(19) United States
(12) Patent Application Publication
(10) Pub. No.: US 2008/0220194 A1
(43) Pub. Date: Sep. 11, 2008

(54) Kit for adhesive products

(76) Inventor: Ross Alan Spalding Burnham, Stow, OH (US)

Correspondence Address: BEMIS COMPANY, INC.;Patent and Trademark Department, 2200 BADGER AVENUE, OSHKOSH, WI, 54904, US

(21) Appl. No.: 11/715,708

(22) Filed: Mar. 8, 2007

(51) Int. Cl. B32B 9/00

(52) U.S. Cl. 428/41.8

(57) ABSTRACT

The present invention provides a kit for an adhesive product comprising a coil of non-foam double-sided adhesive tape, a plurality of substantially flat segments of non-foam double-sided adhesive tape, or combinations thereof, and a display package having a storage volume sized to enclose therewithin and allow removal therefrom the tape. The tape includes an adhesive layer having a first surface, a second surface, a thickness of between 10 to 30 mil and consisting essentially of a non-silicone containing pressure sensitive adhesive.

### TECHNICAL FIELD

This invention relates to kits for an adhesive product; and in particular, this invention relates to kits for adhesive product which comprises a coil of non-foam adhesive tape, a plurality of substantially flat segments of non-foam adhesive tape or combinations thereof, and a container.

### BACKGROUND OF THE INVENTION

Consumers have found double-sided adhesive tapes useful for many applications that require attaching two or more objects together. In the craft and hobby and “do-it-yourself” home improvement industries, the need exists for double-side adhesive tapes which replace of use of liquid and hot melt glue adhesives for adhering objects together of various materials and surfaces. In general, double-sided adhesive tapes having a foam core are known in the art. Typically, tapes having a foam core include a polymer matrix having a density that is lower than the density of the polymer matrix itself. Density reduction of foam cores in adhesive tapes is achieved in a number of ways including through creation of gas-filled voids in the matrix (e.g., by means of a blowing agent) or inclusion of polymeric microspheres (e.g., expandable microspheres) or non-polymeric microspheres (e.g., glass microspheres). It is generally recognized by those skilled in the art that adhesive forms are compressible which allows for proper wetting to uneven or irregular surfaces, e.g., masonry, wood, paper, roughened plastics and the like, and therefore, improves adhesion to these surfaces. To date, the ability to provide the consumer a double-sided adhesive tape that conforms and bonds easily to objects with an irregular surface has been limited to adhesive foams and adhesive coated foams or sponges. To manufacture adhesive foams and adhesive coated sponges requires special chemical ingredients and/or additional manufacturing techniques and equipment that produce gas bubbles in the polymer adhesive core, all of which adds to the cost of the finished article. Typically, double-sided adhesive foam tapes are sold as a coil which then requires the use of a cutting instrument, i.e., scissors or knife, to cut a portion of tape when the adhesive application requires less than the entire length of the coil.

In general, non-foam double-sided adhesive tapes are also known in the art and, in contrast to adhesive foams and adhesive coated sponges, are relatively thin (5 mil or less) and non-compressible. Typically, these tapes are designed to bond easily to two smooth solid surface, such as paper, metal, glass, and plastic. However, low-energy plastic surfaces, such as plastics, particularly, polyolefin, polycarbonate and fluorocarbon plastics, are inherently difficult to bond to because of poor wetting that results between the adhesive and substrate.

Accordingly, many consumers desire a double-sided adhesive tape which possesses the ability to bond to rough or textured surfaces while maintaining a capacity to strongly adhere relatively smooth low-energy plastic surfaces.

### BRIEF SUMMARY OF THE INVENTION

The present invention provides kits for an adhesive product comprising a coil of non-foam double-sided adhesive tape, a plurality of substantially flat segments of non-foam double-sided adhesive tape, or combinations thereof, and a display package having a storage volume sized to enclose therewithin and allow removal therefrom the tape.

Each kit includes a non-foam double-sided adhesive tape which comprises an adhesive layer and at least a first release liner. The adhesive layer has a first surface, a second surface, and a thickness of between 10 to 30 mil, and comprise a pressure sensitive adhesive. The adhesive layer may consist essentially of a non-silicone containing pressure sensitive adhesive. The release liner is removably adhered to the first surface of the adhesive layer and comprises a flexible release liner web and a layer of release material on the release liner web in contact with the first surface of the adhesive layer.

One advantage of the present invention is that each kit provides a non-foam double-sided adhesive tape which may bond to two dissimilar surfaces, i.e., rough or textured surfaces and smooth surfaces. Rough or textured surface can include such materials as masonry material, unfinished wood, woven and nonwoven fabrics and the like. The kits provide a tape having an adhesive which can flow into and fill the cavities of the uneven surfaces. Smooth surfaces may include painted surfaces, paper, metal and plastic materials, e.g., polyolefin, nylon, and polycarbonate plastics, particularly, polyolefin plastics with low-energy surfaces properties, i.e., polyethylene, polypropylene and blends thereof. The kits also provide a tape having an adhesive with good wetting characteristics to smooth surface, particularly, and at least a first release liner.

Another advantage of the present invention is that each kit provides a non-foam double-sided adhesive tape in a form of either a continuous coil of single- or double-lined tape, a plurality of substantially flat segments of double-lined tape or a combination thereof. The kits provide coils of non-foam double-sided adhesive tape having a total width of at least 0.25 inch, preferably, between 0.25 to 11 inch, more preferably, between 1 to 2 inch, and most preferably, about 1 inch; and a total length of at least 6 inch, preferably, between 20 to 250 inch, more preferably, between 40 to 80 inch, and most preferably, about 60 inch. The kits also provide a plurality of substantially flat segments of non-foam adhesive tape each having a total width of at least 0.25 inch, preferably, between 0.25 to 11 inch, more preferably, between 1 to 2 inch, and most preferably, about 1 inch; and a total length of at least 0.25 inch, preferably, between 0.50 to 6 inch, more preferably, between 1 to 5 inch, and most preferably, about 3 inch. The total number of individual adhesive segments in each kit may be any number as desired, preferably, the total number of segments per container is between 1 to 500, more preferably, between 1-250, and most preferably, between 1 to 25.

### BRIEF DESCRIPTION OF SEVERAL VIEWS OF THE DRAWINGS

FIG. 1 shows a schematic of a first embodiment of the present invention.

FIG. 2 shows a schematic of a second embodiment of the present invention.

FIG. 3 shows a cross sectional schematic of one embodiment of a non-foam adhesive tape with one release liner according to the present invention.

FIG. 4 shows a cross sectional schematic of another embodiment of an adhesive tape with two release liners according to the present invention.

FIG. 5 shows a cross sectional schematic of another embodiment of an adhesive tape with two release liners illustrating a means for removing the release liners from the adhesive layer according to the present invention.

### DETAILED DESCRIPTION OF THE INVENTION

### Definitions

As used herein, the phrase “pressure sensitive adhesive” (“PSA”) describes an adhesive polymer material which provides high initial adhesion on contact and whose bond strength increases with pressure and/or time. A pressure sensitive adhesive material is tacky at room temperature and is ordinarily a 100% solids composition, i.e., it contains no materials which are liquids at ordinary temperatures. Particulate solid materials, such as fillers, reinforcing agents, antioxidants, colorants, and other solid materials known in the art may be incorporated into the pressure sensitive adhesive material. Solid material loadings ordinarily are in the amount well known to those skilled in the art. Preferably, pressure sensitive adhesives useful in the present invention are hot-melt pressure sensitive adhesives and are free of expandable particulate materials.

As used herein, the phase “hot-melt adhesive” refers to those pressure sensitive adhesives which are melted to cause flow and which are solidified upon cooling after contacting the adherend(s). Hot-melts can be characterized as solidifying by physical processes upon cooling after being applied as a hot liquid.

As used herein, the term “non-foam” refers to a tape structure free of an adhesive foam or adhesive coated foam such that the density of the adhesive foam or adhesive coated foam is less than the density of the polymer matrix alone. One method for determining the density of foam articles is ASTM D792-86 test method which is incorporated herein by reference in its entirety.

As used herein, the term “double-side” refers to adhesive tapes having adhesive properties on both sides of the adhesive substrate which allows joining of two or more items back-to-back or in a superimposed manner.

As used herein, the phrase “display package” refers to a container or package for displaying consumer goods at the point of sale. In general, a display package may include a semi-rigid transparent plastic shell, typically shaped in some fashion to conform at least in part to the shape of the retained consumer goods. The back of such packages may be plastic but typically may be cardboard with product information printed thereon; alternatively, a card may be placed inside of a package having both front and back plastic panels or shells, sometimes called a clamshell package.

As used herein, the phrases “low energy surface” and “low surface energy” are used interchangeable and both refer to substrates having an inherent surface energy of less than about 50 dynes per centimeter, more typically less than about 45 dynes per centimeter, and most typically less than about 35 dynes per centimeter. For example, the surface energy of polyamide is 46, polycarbonate is 46, polyethylene terephthalate is 43, polyethylene is 31, polystyrene is 33, polytetrafluoroethylene is 18 and polyvinyl chloride is 39. One test method useful for determining surface energy of plastic substrates is ASTM 2578 test method, which is incorporated herein by reference in its entirety.

As used herein, the phrase “peel adhesion strength” refers to the peel adhesion of pressure sensitive adhesive tapes. In general, peel adhesion of a pressure sensitive tape is the force required to remove a tape from a test panel or its own backing at a controlled angle and at a standard rate and condition. Specifically, peel adhesion strength when used in reference to the present invention refers the force required to remove the tape from a stainless steel panel at an angle of 180 degrees with a 30 minute residence in accordance with Method E of the Pressure Sensitive Tape Council test method, PSTC 101, which is incorporated herein by reference in its entirety.

As used herein, the phrase “shear strength” refers to the ability of a pressure sensitive adhesive tape to remain adhered under a constant load applied to the surface of the tape and substrate. Shear adhesion (shear resistance) is the ability of an adhesive tape to resist static forces applied in the same plane as the backing. Specifically, shear strength when used in reference to the present invention refers the shear adhesion of the tape when applied to a vertical standard stainless steel panel in accordance with Procedure A of the Pressure Sensitive Tape Council test method, PSTC 107, which is incorporated herein by reference in its entirety.

As used herein, the phrase “substantially flat” refers to a substrate that is nearly flat or planar in design and lies flat when the substrate is placed in a lay flat position.

As used herein, the phrase “expandable particulate” refers to a material specifically designed to produce adhesive foam or sponge-like materials which are added to an adhesive composition whose overall dimensions increase upon heating at a specific temperature. Expandable particulates may include those materials comprised of a polymeric shell and a core of at least one other material, either liquid or gaseous, most preferably a liquid at room temperature.

As used herein, the phrase “masonry material” describes materials which include brick, stone, ceramic, concrete, tile, plaster, sheetrock, stucco, and similar materials.

As used herein, the phrase “woven and nonwoven fabrics” refers to woven natural and synthetic textiles, for example, but not limited to, cotton, linen, silk, polyester, rayon, nylon and the like, and nonwoven fabric, i.e., rope, cord, jute, string and similar materials.

As used herein, the term “paper” refers to substantially flat cellulosic materials which may include Kraft paper, wallpaper and the like.

A “polymer” as used herein, refers to the product of a polymerization reaction, and is inclusive of homopolymers, copolymers, terpolymers, etc. In general, the layers of a film can consist essentially of a single polymer, or can have still additional polymers together therewith, i.e., blended therewith.

“Polyolefin” is used herein broadly to include polymers such as polyethylene, polypropylene, polybutene, and ethylene copolymers having a majority amount by weight of ethylene polymerized with a lesser amount of a comonomer such as vinyl acetate, and other polymeric resins falling in the “olefin” family classification. Polyolefins may be made by a variety of processes well known in the art including batch and continuous processes using single, staged or sequential reactors, slurry, solution and fluidized bed processes and one or more catalysts including for example, heterogeneous and homogeneous systems and Ziegler, Phillips, metallocene, single site and constrained geometry catalysts to produce polymers having different combinations of properties. Such polymers may be highly branched or substantially linear and the branching, dispersity and average molecular weight and may vary depending upon the parameters and processes chosen for their manufacture in accordance with the teachings of the polymer arts.

Although specific embodiments of the present invention will now be described with reference to the drawings, it should be understood that such embodiments are by way of example only and merely illustrative of but a small number of the many possible specific embodiments which can represent applications of the principles of the present invention.

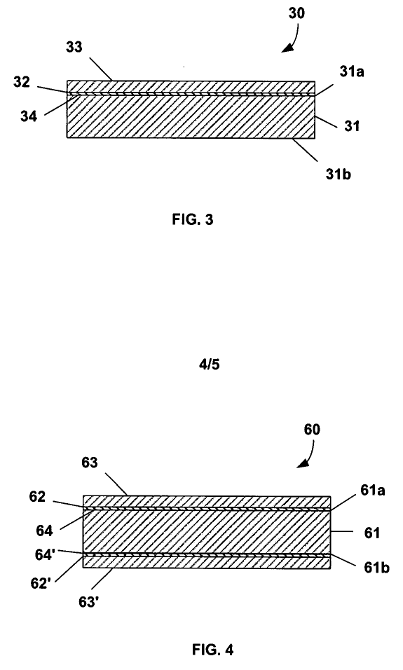

Referring to FIG. 1, there is illustrated a preferred embodiment of the present invention of a kit for an adhesive product, 10. In a preferred embodiment, the kit for an adhesive product, 10, comprises a coil, 20, of non-foam double-sided adhesive tape, 30 (see FIG. 3) and a display package, 40. As depicted in this embodiment, display package, 40, includes a display card, 41, which provides a generally stiff supportive backing, usually composed of cardboard or plastic, and a thermoformed plastic, 42, which is die cut and bonded to the display card. The supportive backing and thermoformed plastic are held together to define a cavity, 43 having a shape to fit over and coil, 20, contained within the package. Display card, 41, provides support for displaying kit, 10, for sale and usually contains print with suitable indicia, such as advertising, trademarks, and instructions. As is known in the art, this type of package is referred to as a blister package or “blister-pack.” Generally, package 40 includes a transparent window, 44, for viewing coil, 20, which can be formed from a piece of clear polymeric material, e.g., plastic, heat sealed to the display card. The display package isolates the adhesive tape from the consumer and prevents inadvertent damage to the tape that can result from repeated handling prior to sale, while further allowing for the orderly display of tape for sale to consumers. Broadly, the display package may be formed from any suitable material and vary in size, shape and form without departing from the scope and spirit of the present invention. Coil 20 has a width of about 1.0 inch and a total length of about 60.0 inch. Adhesive tape 30 of coil 20 may include a first and second release layer (not shown) and a means for removing each release layer (not shown), preferably, tape 30 includes one release layer and a means for removing one release layer.

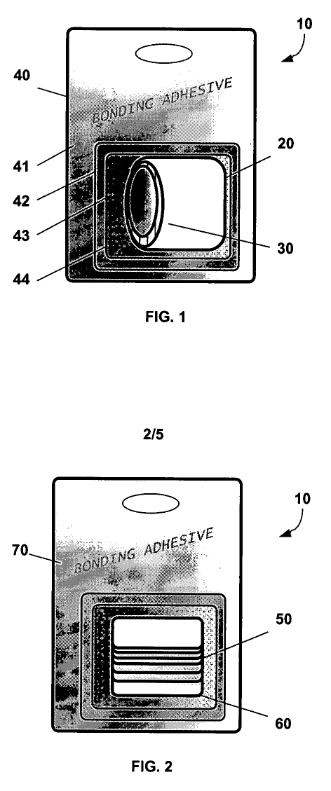

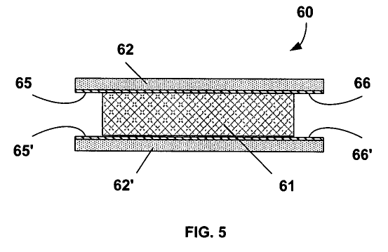

Another preferred embodiment of the present invention of a kit for an adhesive product, 10, is shown in FIG. 2 which comprises a plurality of substantially flat segments 50 of non-foam double-sided adhesive tape 60 (see FIG. 4) and a display package 70. In this embodiment, each of the substantially flat segments of double-side adhesive tape, 60, have a total width of about 1 inch and a total length of about 3 inch. Display package 70 is a blister package similar to the package 40 described above. Tape 60 may include a first release liner and a means for removing the first release liner (not shown), preferably, tape 60 includes a first and second liner and a means for removing the first and second release liner (see FIG. 5).

Referring to FIG. 3, there is illustrated a partial side view in cross-section of non-foam double-side adhesive tape, 30, in accordance with the present invention. As illustrated, tape 30 comprises an adhesive layer, 31, and one release liner 32. Adhesive layer 31 has a first surface, 31a, a second surface, 31b, and comprises a pressure sensitive adhesive. Adhesive layer 31 may consist essentially of a non-silicone containing pressure sensitive adhesive. In a preferred embodiment, the adhesive layer 31 comprises a hot-melt pressure sensitive adhesive. It will be apparent to those skilled in the art that adhesive layer 31 when formed from a hot-melt pressure sensitive adhesive is highly viscous at ordinary room temperature conditions. The pressure sensitive adhesive (PSA) may be chosen from the following polymers or polymer blends: urethanes, rubbers, acrylics, polyesters, and vinyls. Preferably, the PSA is a non-acrylic pressure sensitive adhesive. It will be understood that without departing from the true scope and spirit of the present invention the pressure sensitive adhesive may further include additives and like ingredients, such as colorants, fillers surfactants, crosslinking agents or catalysts, etc. Suitable PSAs may be curable, i.e., crosslinkable, by various methods known in the art which include exposing the polymer adhesive to ultraviolet and electron-beam radiation or heat. The PSA useful in the present may include hot-melt pressure sensitive adhesives which are known in the art. Examples of commercial hot-melt pressure sensitive adhesives would include those sold by National Starch and Chemical Company, Bridgewater, N.J., U.S.A.; H. B. Fuller, St. Paul, Minn., U.S.A. or Bostik, Inc., Wauwatosa, Wisc., U.S.A. Hot-melt pressure sensitive adhesives may include A-B-A block copolymers such as those disclosed in U.S. Pat. No. 5,342,858, which is incorporated herein by reference in its entirety. The A block is typically an alkenyl arene polymer derived from a monomer such as styrene. The B block is typically a polymer of a conjugated aliphatic diene monomer of 4 to 6 carbon atoms or a linear alkene monomer of 2 to 6 carbon atoms. Suitable alkenes include butadiene, isoprene and the like. Suitable alkenes include ethylene, propylene, butylene and the like. When the A block is styrene-based and the B block is butadiene-based or isoprene-based, the block copolymers are referred to as S-B-S copolymers and S-I-S copolymers, respectively. The thickness of adhesive layer 31 is between 10 to 30 mil, preferably, 15 to 25 mil, more preferably, 18 to 22 mil.

As depicted, release liner 32 comprises a release liner web, 33, and a layer of release material, 34, disposed on release liner web 32 and in contact with the first surface, 31a, of adhesive layer 31. Release liner web 33 may be any suitable liner web such as paper or monolayer or multilayer polymeric film. Preferably, release liner web, 33 is a release paper, e.g., a 40 pound, 50 pound, 60 pound or 80 pound release paper (40 pounds denotes a weight of 0.066 kg/m²). Release material 34 may be any conventional release material. Suitable examples include silicone-based and fluorosilicone-based release polymer, which can be coated, sprayed or extruded onto release liner web 33 in accordance with known techniques. In operation, non-foam double-sided adhesive tape 30 is cut to a desired length using a sharp cutting instrument such as a knife or scissors and the first surface of adhesive layer 31 a is placed on a first object using light pressure to cause the adhesive layer 31 to adhere to the surface of the object. After tape 30 is affixed to the object, release liner 32 can be removed from adhesive layer 31 by lifting the edge of release liner 32 (see FIG. 5) and pulling away from adhesive layer 31, thereby exposing the second surface of adhesive layer 31b. Preferably, release liner 32 (see discussion below and FIG. 5) includes a means for removing release liner 32 from adhesive layer 31. Once the release liner 32 is removed, a second object may be superimposed onto the first object by placing the second object on the exposed second surface of adhesive layer 31 b and applying slight pressure thereto. Tape 30 and 60 (discussed below) may form a permanent or non-permanent bond to the surface of one of more objects to which it is affixed, preferably, a permanent bond is formed between tape 30 or 60 (described below) and the surface of one or more objects adhered thereto.

In accordance with the present invention, a strip of non-foam double-side adhesive tape 30 was tested and found to have the following properties. All tests used a strip of double-sided pressure sensitive adhesive tape having a width of 1.5 inch with an adhesive layer having a width of 1.0 inch and a total thickness of 20 mil, as test specimens, and a stainless steel panel as the substrate. The peel adhesion strength was measured by following the test protocol as outlined in PSTC 101, Method E, and a value of 20 pound/inch² with 30 minute residence time was found. The shear strength was determined by test method PSTC 107, Procedure A, and a value of 1000 gram/inch² at 72° F. was found.

FIG. 4 illustrates a partial side view in cross-section of non-foam double-side adhesive tape, 60, in accordance with the present invention. Tape 60 includes adhesive layer 61 having a first surface, 61a, a second surface, 61b, and comprising a pressure sensitive adhesive. Adhesive layer 61 is a pressure sensitive adhesive as described above for adhesive layer 31 for tape 30 (see FIG. 3). As illustrated, tape 60 further includes a first release liner, 62, and a second release liner, 62′. First and second release liners, 62 and 62′, each comprise a layer of release liner web, 63, 63′, and a release material, 64, 64′, respectively. Release liners 62 and 62′ each have release materials, 64, 64′, disposed between the release liner webs, 63, 63′, and first surface, 61a, and a second surface, 61b, respectively. Release liner webs 62 and 62′ may be constructed from the same materials described above for release liner 33, and preferably, are each formed from paper. Similarly, release materials 64 and 64′ may each include silicone-based, fluorosilicone-based release polymer, or any other suitable release material which can be applied onto the release liner web.

Referring to FIG. 5, there is illustrated a partial head-on view in cross-section of non-foam double-side adhesive tape, 60, having a means for removing both release liners, 62 and 62′ from adhesive layer 61. In this embodiment, the means for removing release liner 62 comprises both a first distal portion of said first release liner, 65, and a second distal portion of said first release liner, 66, each extending beyond one edge of said adhesive layer to a distance at least 0.125 inch, preferably, 0.250 inch, which extends beyond one edge of said adhesive layer 61. Similarly, means for removing release liner 62′ comprises both a first distal portion of said first release liner, 65′, and a second distal portion of said first release liner, 66′, each extending beyond one edge of said adhesive layer to a distance of at least 0.125 inch, preferably, 0.250 inch. It will be understood by those skilled in the art that the means for removing the first release liner 62 or second release liner 62′ from adhesive layer 61 may include only a single distal portion of each release liner, i.e., 65 or 66, and 65′ or 66′, respectively. In use, either release liner 62 or 62′ may be removed from adhesive layer 31. For example, release liner 62 is removed by grasping the extended edge of the release liner 62 at either means for removing release liner 65 or 66, and pulling away from adhesive layer 31. Alternatively, release liner 62′ may be removed by grasping the extended edge of the release liner 62′ at either means for removing release liner 65′ or 66′, and pulling away from adhesive layer 31. In these examples, removing release liner 62 or 62′ exposes a first surface of adhesive layer 31a or 31b (see FIG. 4). After the first release liner is removed, the tape may be placed onto the surface of a first object by application of pressure. Once affixed, the second release liner is removed from the tape in a manner identical to that for removing the first release liner as described above. After the second release liner is removed, a second object may be bonded to the second exposed surface of adhesive layer by placing onto the adhesive layer and applying gentle pressure.

The manufacture of tapes 30 and 60 may be accomplished according to known manufacturing techniques. For example, U.S. Pat. No. 5,773,080 describes a process for manufacturing non-foam double-sided adhesive tapes having thicknesses of 10-100 mil by extrusion of an adhesive material onto a substrate. This patent discloses a process where the substrate is chilled on a chilled drum to avoid foam formation of the adhesive; typically, when the temperature of the substrate is approximately between 80 to 100° F., a non-foam double-sided adhesive may be produced. U.S. Pat. No. 5,773,080 describes processes that may be adjusted to provide either a continuous strip of non-foam adhesive or intermittent non-foam adhesive strips of a desired pattern. Preferably, the non-foam double-sided adhesive tapes of the present invention are manufactured in accordance with the process described in U.S. Pat. No. 5,773,080, which is incorporated herein by reference in its entirety. Preferably, suitable substrates for use in the present invention are either a release liner or a release web.

It will be apparent to those skilled in the art that modifications and additions can be made to the various embodiments described above, without departing from the true scope and spirit of the present invention. It should be understood that this invention is not intended to be unduly limited by the illustrative embodiments set forth herein and that such embodiments are presented by way of example only with the scope of the invention intended to be limited only by the claims set forth herein as follows.

What is claimed is:

1. A kit for an adhesive product comprising:
a) a coil of non-foam double-sided adhesive tape, a plurality of substantially flat segments of non-foam double-sided adhesive tape or a combination of a coil of non-foam double-sided adhesive tape and at least one substantially flat segment of non-foam double-sided adhesive tape;
b) a display package having a storage volume sized to enclose therewithin and allow removal therefrom said tape;
wherein said tape comprises:
i) an adhesive layer having a first surface, a second surface, a thickness of between 10 to 30 mil and comprising a pressure sensitive adhesive;
ii) at least a first release liner removably adhered to said first surface of said adhesive layer comprising;
a flexible release liner web;
a layer of release material on said release liner web in contact with said first surface of said adhesive layer; and
wherein said tape is adapted to bond together two or more adherends selected from a first group consisting of masonry material, unfinished wood, woven and nonwoven fabric, and a second group consisting of painted surface, paper, metal and plastic material.

2. The kit according to claim 1, wherein said adhesive layer has a thickness of between 15 to 25 mil.

3. The kit according to claim 1, wherein said adhesive layer has a thickness of between 18 to 22 mil.

4. The kit according to claim 1, wherein said tape has a peel adhesion strength of at least 10 pound/inch².

5. The kit according to claim 1, wherein said tape has a peel adhesion strength of at least 20 pound/inch².

6. The kit according to claim 1, wherein said tape has a shear strength of 1000 gram/inch².

7. The kit according to claim 1, wherein said tape further comprises a second release liner removably adhered to said second surface of said adhesive layer comprising a flexible release liner web and a layer of silicone release material on said release liner web in contact with said second surface of said adhesive layer.

8. The kit according to claim 1, wherein said tape further comprises a means for removing said first release liner from said adhesive layer comprising a distal portion of said first release liner extending beyond one edge of said adhesive layer to a distance of at least 0.125 inch.

9. The kit according to claim 7, wherein said tape further comprises a means for removing said second release liner from said adhesive layer comprising a distal portion of said second release liner extending beyond one edge of said adhesive layer to a distance of at least 0.125 inch.

10. The kit according to claim 1, wherein said plastic material is selected from the group consisting of polyolefin, nylon, polycarbonate and blends thereof.

11. The kit according to claim 1, wherein said plastic material is a polyolefin plastic selected from the group consisting of polyethylene, polypropylene and blends thereof.

12. The kit according to claim 1, wherein said adhesive layer consists essentially of a non-silicone containing hot-melt pressure sensitive adhesive and is free of expandable particulate materials.

13. The kit according to claim 1, wherein said release liner web is paper.

14. The kit according to claim 1, wherein said coil of non-foam double-sided adhesive tape and said plurality of substantially flat segments of non-foam double-sided adhesive tape each have a total width of between 0.25 to 11 inch.

15. The kit according to claim 1, wherein said coil of non-foam double-sided adhesive tape has a total length of between 6 to 250 inch.

16. The kit according to claim 1, wherein said plurality of substantially flat segments of non-foam double-sided adhesive tape each have a total length of between 0.25 to 11 inch.

17. A kit for an adhesive product for sale to a consumer comprising:
a) a coil of non-foam double-sided adhesive tape;
b) a display package having a storage volume sized to enclose therewithin and allow removal therefrom said tape;
wherein said tape comprises:
i) an adhesive layer having a first surface, a second surface, a thickness of between 18 to 22 mil and comprising a pressure sensitive adhesive;
ii) at least a first release liner removably adhered to said first surface of said adhesive layer comprising;
a flexible release liner web;
a layer of release material on said release liner web in contact with said first surface of said adhesive layer;
iii) a means for removing said first release liner from said adhesive layer comprising a distal portion of said first release liner extending beyond one edge of said adhesive layer to a distance of at least 0.125 inch; and
wherein said tape is adapted to bond together two or more adherends selected from a first group consisting of masonry material, unfinished wood, woven and nonwoven fabric, and a second group consisting of painted surface, paper, metal and plastic material.

18. The kit according to claim 17, wherein said coil has a total width of between 0.25 to 6 inch and a total length of between 12 to 100 inch.

19. The kit according to claim 17, wherein said tape has a peel adhesion strength of at least 20 pound/inch² and a shear strength of 1000 gram/inch².

20. The kit according to claim 17, wherein said adhesive layer consists essentially of a non-silicone containing hot-melt pressure sensitive adhesive and is free of expandable particulate materials.

21. The kit according to claim 17, wherein said plastic material is a polyolefin plastic selected from the group consisting of polyethylene, polypropylene and blends thereof.

22. The kit according to claim 17, wherein said plastic material is a polyolefin material selected from the group consisting of polyethylene, polypropylene and blends thereof.

23. The kit according to claim 17, wherein said tape further comprises a second release liner removably adhered to said second surface of said adhesive layer comprising a flexible release liner web and a layer of silicone release material on said release liner web in contact with said second surface of said adhesive layer.

24. The kit according to claim 23, wherein said tape further comprises a means for removing said second release liner from said adhesive layer comprising at least one distal portion of said second release liner having a length of at least 0.125 inch which extends beyond one edge of said adhesive layer.

25. A kit for an adhesive product for sale to a consumer comprising:
a) a plurality of substantially flat segments of non-foam double-sided adhesive tape;
b) a display package having a storage volume sized to enclose therewithin and allow removal therefrom said tape;
wherein said tape comprises:
i) an adhesive layer having a first surface, a second surface, a thickness of between 18 to 22 mil and comprising a pressure sensitive adhesive;
ii) a first release liner removably adhered to said first surface of said adhesive layer comprising;
a flexible release liner web;
a layer of release material on said release liner web in contact with said first surface of said adhesive layer;
iii) a second release liner removably adhered to said second surface of said adhesive layer comprising;
a flexible release liner web;
a layer of release material on said release liner web in contact with said second surface of said adhesive layer;
iv) a means for removing said first release liner from said adhesive layer comprising a distal portion of said first release liner extending beyond one edge of said adhesive layer to a distance of at least 0.125 inch;
v) a means for removing said second release liner from said adhesive layer comprising a distal portion of said second release liner extending beyond one edge of said adhesive layer to a distance of at least 0.125 inch; and
wherein said tape is adapted to bond together two or more adherends selected from a first group consisting of masonry material, unfinished wood, woven and nonwoven fabric, and a second group consisting of painted surface, paper, metal and plastic material.

26. The kit according to claim 25, wherein said plurality of substantially flat segments of non-foam double-sided adhesive tape each has a total width of between 0.25 to 11 inch and a total length of between 0.25 to 100 inch.

27. The kit according to claim 25, wherein said tape has a peel adhesion strength of at least 20 pound/inch² and a shear strength of 1000 gram/inch².

28. The kit according to claim 25, wherein said adhesive layer consists essentially of a non-silicone containing hot-melt pressure sensitive adhesive and is free of expandable particulate materials.

29. The kit according to claim 25, wherein said plastic material is a polyolefin plastic selected from the group consisting of polyethylene, polypropylene and blends thereof.

30. The kit according to claim 25, wherein said plastic material is a polyolefin plastic selected from the group consisting of polyethylene, polypropylene and blends thereof.
